(19) United States
(12) Patent Application Publication
(10) Pub. No.: US 2011/0307362 A1
(43) Pub. Date: Dec. 15, 2011

(54) Method of Pay for Performance Accounting

(76) Inventor: MARCOS LARA, NEW YORK, NY (US)

(21) Appl. No.: 12/964,400

(22) Filed: Dec. 9, 2010

Related U.S. Application Data
(60) Provisional application No. 61/285,146, filed on Dec. 9, 2009.
(60) Provisional application No. 61/321,443, filed on Apr. 6, 2010.
(60) Provisional application No. 61/323,540, filed on Apr. 13, 2010.
(60) Provisional application No. 61/323,456, filed on Apr. 13, 2010.

(51) Int. Cl. G06Q 30/00

(52) U.S. Cl. 705/34; 705/30

(57) ABSTRACT

A method of accounting for the consumption of digital material. By facilitating a dynamically sourced, streaming performance of digital material and then reporting the occurrence of the performance and the audience that was estimated to be listening to the performance, a performance value may be assessed, and the rights holders informed. The audience may then be billed and the digital material rights holder compensated. In response to a request for a performance of digital material, a performance device may be provided a location of a mechanical containing the material. The performance device may then stream a performance of the digital material without providing copyable access to the digital material mechanical. The streamed performance is accounted for, making the nature and location of the performance mechanical irrelevant.

### CLAIM OF PRIORITY

This application claims priority to U.S. Provisional Patent No. 61/285,146 entitled “Sharing Metadata on Mobile Platforms” filed on Dec. 9, 2009, the contents of which are fully incorporated herein by reference. This application also claims priority to U.S. Provisional Patent No. 61/321,443 entitled “Metadata combination for serialized content delivery to “N” users” filed on Apr. 6, 2010, U.S. Provisional Patent No. 61/323,540 entitled “Authentication System for a Mobile-enabled data sharing application” filed on Apr. 13, 2010 and to U.S. Provisional Patent No. 61/323,456 entitled “Vertical Neutral “N” User Metadata Comparisons” filed on Apr. 13, 2010 the contents of all of which are fully incorporated herein by reference.

### FIELD OF THE INVENTION

The invention relates to computer implemented methods of pay for performance accounting, and more particularly to computer implemented methods of tracking performances of artistic works for the purpose of informing copyrights holders, assessing performance values and billing performance audiences.

### BACKGROUND OF THE INVENTION

The advent of easily distributed digital content poses a challenge to content providers across all media. The traditional, or analogue, business models of most media distribution organizations relies to a great extent on being able to sell a difficult to copy physical object containing the content. As long as copying the object was either prohibitively difficult, or produced noticeably inferior quality, the artists, record labels and other organizations could control their rights by controlling the production and distribution of the physical media containing the analogue content.

Digital content, however, is easily copied with absolutely no degradation in quality. The result is that as the available bandwidth on the Internet has increased, each type of traditional media distribution model has become compromised, starting with text and progressing through images, music and on to video. The content providing companies have tried with varying degrees of failure, to maintain their analogue approach of controlling the production and distribution of physical embodiments of the content.

The method of the present invention solves the problem of obtaining compensation for the creators of content by controlling the performance of the digital content, rather than trying to control the digital material mechanical, i.e., the physical embodiment of the content that may be a digital electronic file. The method of the invention provides a means to count who is consuming the content and provide a fair and easily implemented platform to charge the audience for the content they consume.

The method is such that the ownership, or custody, of the physical files, or mechanicals, becomes more or less irrelevant. For example, even if a song is sourced from an off-shore hacker, and is both stolen and unlicensed, when it is played, or performed, through the platform of this invention, it effectively becomes licensed for that performance, and the rights holders are compensated. The method of this invention allows users to source digital files from any convenient source they have access to, without violating the content creator's rights.

### DESCRIPTION OF THE RELATED ART

The relevant prior art involving digital content includes:

U.S. Pat. No. 7,444,306 issued to Varble on Oct. 28, 2008 entitled “Method and apparatus for the rental or sale, and secure distribution of digital content” that describes an apparatus for the rental or sale, and distribution of digital content via the Internet. This apparatus ensures enforcement of copyrights and end-use licensing. The invention consists of one or more databases, for the storage of digital content, and also for storage of customer profile and billing information. These databases are housed in multiple networked computers, sharing a private connection to an Internet firewall, gateway computer. This computer hosts an electronic commerce web site for customer purchase transactions and encryption of digital content prior to customer download. The invention also includes a software client application for decrypting and using the digital content. The invention also provides for computer software to manage the digital content inventory of each customer.

U.S. Pat. No. 7,237,123 issued to LeVine, et al. on Jun. 26, 2007 entitled “Systems and methods for preventing unauthorized use of digital content” that describes a how theft, distribution, and piracy of digital content (software, video, audio, e-books, any content of any kind that is digitally stored and distributed) is generally accomplished by copying it, if possible, or, if it is protected from being copied in any fashion, such piracy is based upon a number of reverse engineering techniques. Aside from the straightforward copying of unprotected content, all of these other methods require first an understanding of the protective mechanism(s) guarding the content, and finally an unauthorized modification of that protection in order to disable or subvert it. Methods that prevent a skilled individual from using reverse engineering tools and techniques to attain that level of understanding and/or prevent anyone from performing such modifications can offer significant advantages to content creators who wish to protect their products.

U.S. Pat. No. 7,120,604 issued to Maari on Oct. 10, 2006 entitled “Method of controlling digital content distribution, a method of reproducing digital content, and an apparatus using the same” that describes a digital content distribution control method, a digital content reproducing method, and a digital content reproducing apparatus. The digital content distributing side manipulates digital content by encrypting and compressing the same, transmits the manipulated digital content, an encrypted content key, and encrypted billing information to the other party of communication, and distributes to digital content proprietors the digital content usage fees collected based on digital content usage information received from the other party. On the other hand, the digital content reproducing side decrypts, in a single portable terminal, the manipulated digital content by the digital key and decompresses the decrypted digital content for reproduction. At the same time, the reproducing side decrements the billing information according to the use of the content and generates content usage information to be transmitted to the content distributing side. The digital content reproducing apparatus associated with the present invention is made portable to solve the above-mentioned problems.

Various implements are known in the art, but fail to address all of the problems solved by the invention described herein. One embodiment of this invention is illustrated in the accompanying drawings and will be described in more detail herein below.

### SUMMARY OF THE INVENTION

The present invention provides a method of accounting for the consumption of digital material. In a preferred embodiment, the method includes facilitating a performance of digital material by a digital electronic performance device and reporting the performance to a network computer. A performance value may then be assessed, and both the performance rights holders and the performance audience determined. The performance audience, or at least a member of it, may then be billed, or charged, the performance value, and the digital material's rights holder compensated accordingly.

In a further preferred embodiment, the network computer may receive a request for a performance of a particular digital material by a digital electronic performance device. The network computer may then provide a location of the requested digital material mechanical, i.e., a copy of the material. The location may, for instance, be an address such as, but not limited to, a universal resource locator (URL). A performance of the digital material may then be facilitated by, for instance, providing an application module, operative on the digital electronic performance device that enables a streamed performance of the digital material in which there may be no copyable access to the digital material mechanical.

In one implementation, the application may limit control of the performance to a fixed set of functions such as, but not limited to, starting, stopping, controlling a volume of, skipping, fast forwarding, registering a love for, registering a hate for and repeating the performance.

In assessing a performance value, the number of people within listening range of the digital electronic performance device may be determined and may be factored in to the value assessment. The occurrence of the performance and the performance value may then be reported to an owner of the digital material or of the performance rights to the material.

Therefore, the present invention succeeds in conferring the following, and others not mentioned, desirable and useful benefits and objectives.

It is an object of the present invention to provide a means to pay for each performance of digital media.

It is another object of the present invention to provide a cloud based content delivery and rights management system that helps eliminate unlicensed content distribution.

Yet another object of the present invention is to provide the end user with maximum control over the performance.

Still another object of the present invention is to provide a streaming delivery system that that minimizes the risk of file sharing by not allowing the user direct access to the file.

Still another object of the present invention is to account for each performance and to compensate the appropriate rights holders.

Yet another object of the present invention is to provide rights holders compensation regardless of the source of the content.

### BRIEF DESCRIPTION OF THE DRAWINGS

FIG. 1 shows a schematic overview of a content distribution and monitoring system in accordance with a preferred embodiment of the present invention.

FIG. 2 shows a flow diagram of steps that may be taken to control a mechanical in a preferred embodiment of the present invention.

FIG. 3 shows a more detailed flow diagram of steps that may be taken to control a mechanical in a preferred embodiment of the present invention.

FIG. 4 shows a schematic interaction diagram showing interactions that may occur in controlling a mechanical in a preferred embodiment of the invention.

FIG. 5 shows a flow diagram of steps that may be taken to account for each performance in a preferred embodiment of the present invention.

FIG. 6 shows a more detailed flow diagram of steps that may be taken to account for each performance in a preferred embodiment of the present invention.

FIG. 7 shows a schematic interaction diagram showing interactions that may occur in accounting for each performance in a preferred embodiment of the invention.

FIG. 8 shows a schematic interaction diagram showing interactions that may occur in payment processing in a preferred embodiment of the invention.

FIG. 9 shows a schematic interaction diagram showing interactions that may occur in dynamic sourcing of a mechanical in a preferred embodiment of the invention.

FIG. 10 shows a schematic interaction diagram showing interactions that may occur in implementing a preferred embodiment of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto. In particular, the following description of the present invention is presented as pertaining to the distribution, consumption and accounting for digital music. One of ordinary skill in the art will readily appreciate that the inventive concepts discussed below may readily be adapted for use in other digital media such as, but not limited to, text, images and video, or some combination thereof.

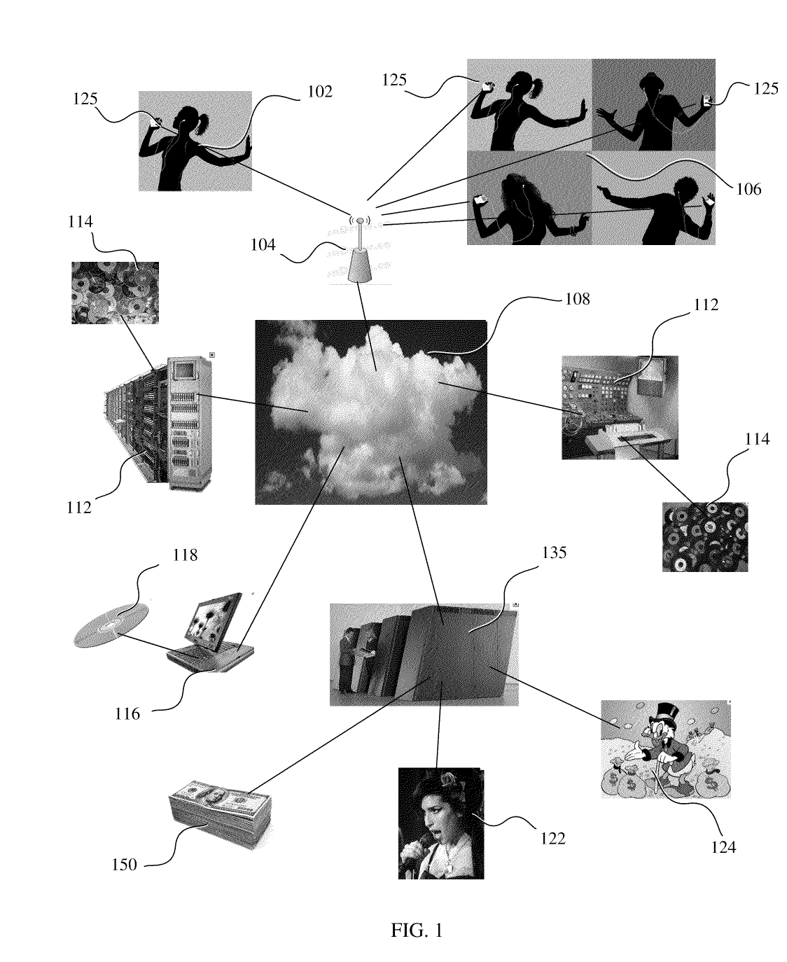

FIG. 1 shows a schematic overview of a content distribution and monitoring system in accordance with a preferred embodiment of the present invention.

In a preferred embodiment of the method of accounting for consumption 100, a user 102 listens to digital music on a digital electronic performance device 125. The digital music may be supplied from, for instance, a third party music archive 114 of a third party server 112 via the Internet 108 and suitable transmission hardware 104.

The performance of the digital material may, for instance, be facilitated by a network computer 135 that may receive reports of the details of the performance from the digital electronic performance device 125.

The network computer 135 may also assess a performance value 150 based on factors such as, but not limited to, the performance audience, the location of the performance and the duration of the performance, or some combination thereof.

The network computer 135 may also determine a performance rights holder 140 of the digital material and a performance audience, and may then bill at least one member of the performance audience the performance value 150.

In this manner, the method of accounting for consumption 100 allows a user 102, or a group of users 106, to access digital material over the Internet 108 from either a user's personal music collection 118 stored on a user's personal computer 116, or from a third party music archive 114 stored on a third party server 112. An application module operative on the digital electronic performance device 125 may ensure that an appropriate performance value 150 is calculated, or assessed, and may inform the performance rights holder 140 and may also facilitate their receiving appropriate compensation. The performance rights holder 140 may, for instance, be the performing artist 122, the record label 124, some third party or some combination thereof.

In a preferred embodiment, the network computer 135 may also determine a performance audience and factor that into a calculation of a performance value 150.

The application module may also ensure that the user 102, or group of users 106, do not have direct, copyable access to the digital copy of the content, also known as the mechanical 160, by providing a streamed performance that may originate from a third party streaming catalogue.

FIG. 2 shows a flow diagram of steps that may be taken to control a mechanical in a preferred embodiment of the present invention.

In Step 202: facilitate a safe performance, a performance application module that may be operative on a digital electronic performance device 125 may facilitate a streamed performance of digital material that does not allow copyable access to the digital copy of the content, also known as the mechanical 160. The application module may also ensure that any data bits retrieved from the digital copy of the content, also known as the mechanical 160 by the digital electronic performance device 125 during delivery of the streamed performance are removed or overwritten, preferably as soon as practicable after they have been used in the performance.

The application module may limit the user's control of the performance to a specific set of functions such as, but not limited to, starting, stopping, controlling a volume of, skipping, fast forwarding, registering love for, registering hate for and repeating the performance. In this way the user may have a desired level of control over the delivery of the content, while not being easily able to copy the material, or to otherwise circumvent the legitimate rights of the content creators and distributors.

In Step 204: report the performance, the digital electronic performance device 125 may report the occurrence of a streamed performance to the network computer 135.

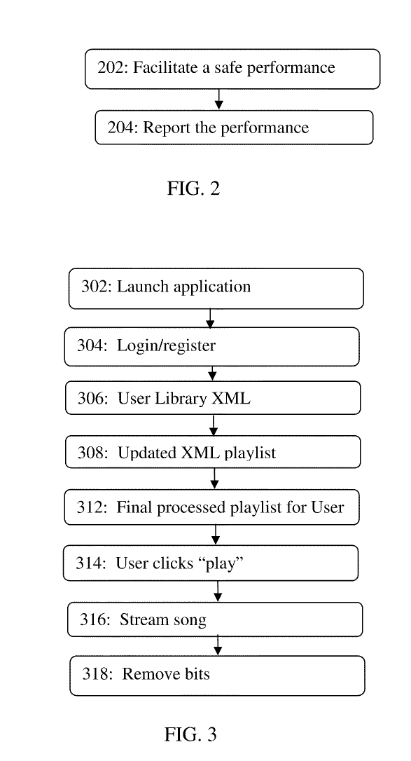

FIG. 3 shows a more detailed flow diagram of steps that may be taken to control a mechanical in a preferred embodiment of the present invention.

In Step 302: Launch application, the application module may be made operational on the digital electronic performance device 125.

In Step 304: Login/register, a user 102 may establish an appropriately secure connection with the network computer 135 that may store relevant data such as, but not limited to, a user profile and preferences.

In Step 306: User Library XML, the network computer 135 may access a profile and preferences file related to the user 102, or the group of users 106. The network computer 135 may also access their user session history, and may use some or all of this data to create a user library that may include playlists that may contain metadata data related to one or more items of digital content. The data stored in the user library may, for instance, for formatted and stored in extensible markup language (XML), or other suitable formatting language.

In Step 308: Updated playlist, the network computer 135 may construct or retrieve one or more of the configured playlists. These may then be delivered to the application module running on the digital electronic performance device 125 in Step 312: Final processed playlist for User. This playlist may not contain any performable material, only the metadata related to that material such as, but not limited to, a song title, a artist name and one or more URLs of sites at which a performable content mechanical may be located.

In Step 314: User clicks “play”, the user may initiate playing of the digital material by making an appropriate selection on the digital electronic performance device 125.

In Step 316: Stream song, the digital material may be streamed, or otherwise relayed, preferably in a suitably encrypted form from the digital copy of the content, also known as the mechanical 160 at the location indicated by the playlist metadata. The digital copy of the content, also known as the mechanical 160 may, for instance, be present on the third party server's 112 third party music archive 114, or on the user's personal music collection 118 that may, for instance, be associated with the user's personal computer 116 or may be stored on a third party website.

In Step 318: Remove bits, the application module running on the digital electronic performance device 125 may remove any information, or bits, that were transmitted from the digital copy of the content, also known as the mechanical 160 from the digital electronic performance device 125.

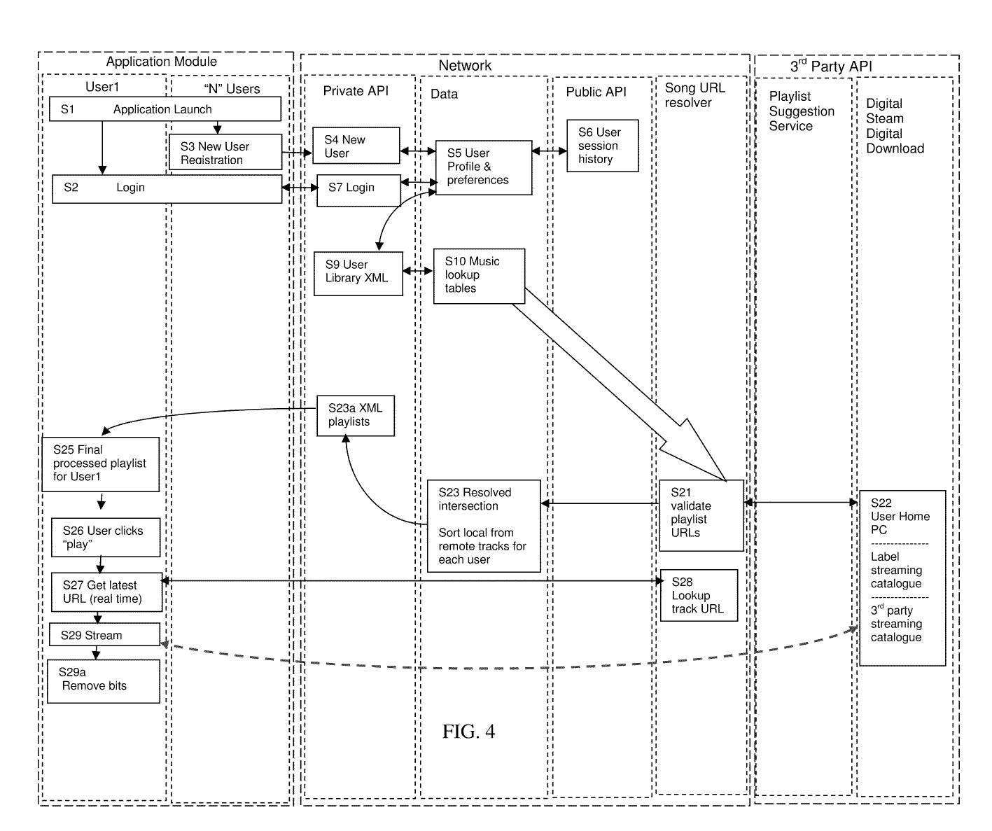

FIG. 4 shows a schematic interaction diagram showing interactions that may occur in controlling a mechanical in a preferred embodiment of the invention.

The interaction begins with the “Application Launch” step S2 in which an application module is initiated, or validated, on a suitable digital electronic performance device 125 such as, but not limited to, an iPod™ or Droid™ smart phone, an iPad™ or other tablet computer, a laptop computer, cellular phone, or some combination thereof.

After launching the application, the user may proceed through the following steps. After the login of step S2 that validates the user on the digital electronic performance device 125, they may then login to the network computer 135 in step S7. They may then access their user profile and preferences in step S5. Using the data obtained, the network computer 135 may retrieve, or generate, a user library that may be formatted in XML, or other formatting language. The user library may, for instance, include indicia such as, but not limited to, song name, artist name or some combination thereof.

In step S9 this user library may be placed in a private API for retrieval by the application module.

In step S10, music lookup tables may be utilized to obtain URLs, or other indicia that may be indicative of a location of a mechanical 160 containing the digital material.

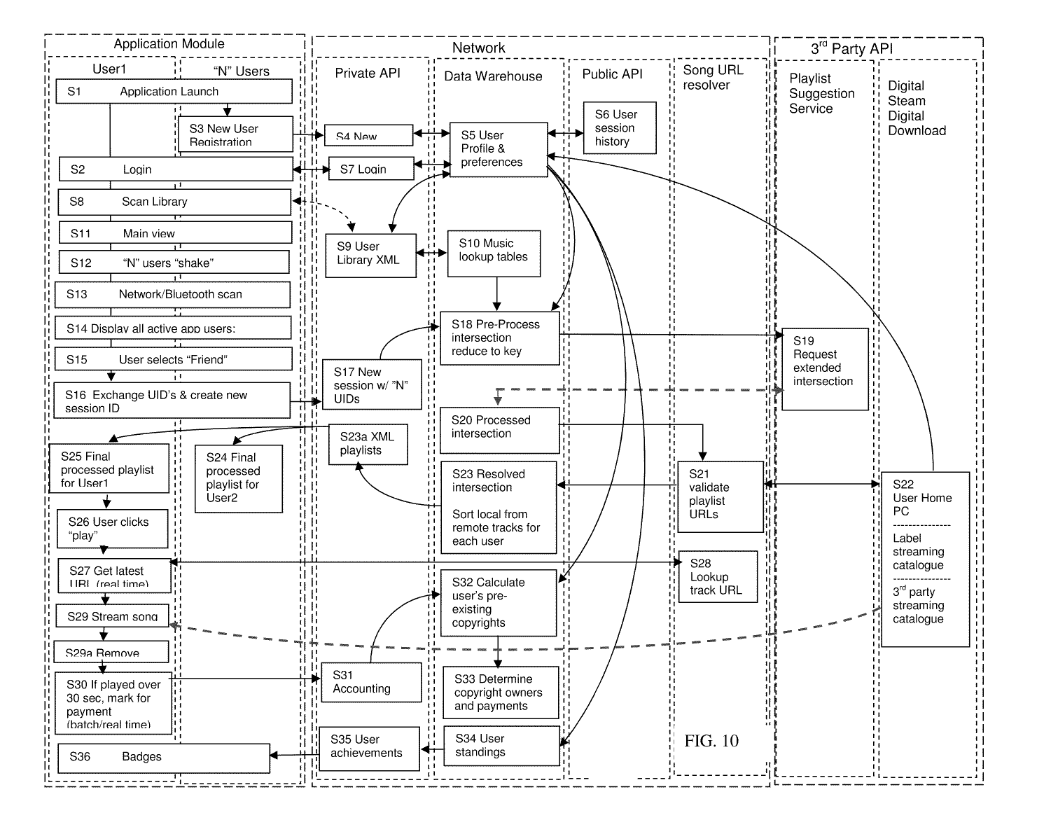

The system may then proceed to validate playlist URLs in step S21 via the steps shown in detail in FIG. 10. The step of validating playlist URLs may, for instance include step S22 of accessing sources for digital stream downloads that may include sources such as, but not limited to, a user's home PC, a record label's streaming catalogue or a 3^{rd} party streaming catalogue, or some combination thereof.

Having validated the playlist URLs, the system may move to step S23 in which the local tracks, i.e., those on the user's PC, or cached on the network computer 135, may be separated from the remote tracks, i.e., those located on 3^{rd} party or label streaming catalogues.

In step, S23A the updated playlists, including the locations of digital copy of the content, also known as the mechanical 160, may be gathered as XML formatted playlists on the network computer 135.

In step S25, the final processed playlist is delivered to the user via the application module running on the digital electronic performance device 125.

In step S26 the user may initiate the performance by, for instance, selecting a song title and pressing a “play” button.

In step S27 the application module may obtain the most up to date location of a digital copy of the content, also known as the mechanical 160 containing the requested digital material by accessing the network computer 135 and looking up the track's URL in step S28.

In step S29, the application module may facilitate the streamed performance from the appropriate source. That source may, for instance, be, but is not limited to, a 3^{rd} party streaming catalogue, a label streaming catalogue or a user's home PC, or some combination thereof.

In step S29A, the application module may remove, or over write, any information that may be related to the digital material so as to reduce the risk of the digital material being copied. The streaming process may, for instance be controlled in such a manner that future content is only delivered when the system is reasonably assured that previously delivered material has been removed from the digital electronic performance device 125.

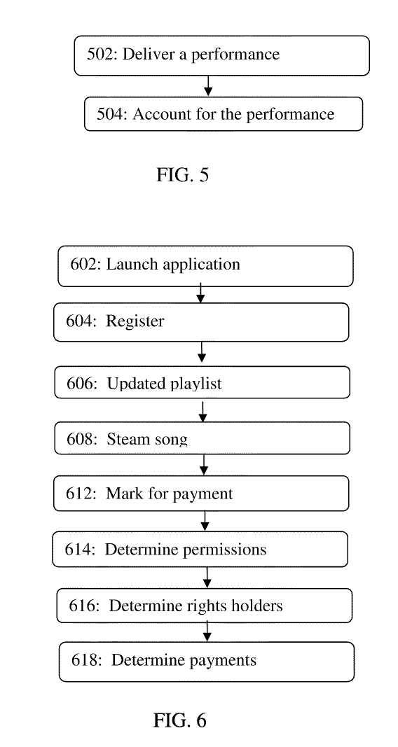

FIG. 5 shows a flow diagram of steps that may be taken to account for each performance in a preferred embodiment of the present invention.

In Step 502: Deliver a performance, an application module may facilitate a performance of digital material. This may, for instance, be, but is not limited to, playing digital music on a suitable platform such as, but not limited to, a smart phone, a mobile computer, a digital electronic performance device 125 or some combination thereof.

In Step 504: Account for the performance, the digital electronic performance device 125, or an application module running on the digital electronic performance device 125, may report the occurrence of a performance to a network computer 135.

The digital electronic performance device 125, or the application module, may also determine, or estimate, the number of people within listening range. The digital electronic performance device 125 may do this by, for instance, electronically monitoring the number of mobile devices within a predetermined distance of the digital electronic performance device 125. The monitoring may, for instance, be accomplished by using a local wireless capability such as, but not limited to, WiFi or Bluetooth. The estimate of the number of people within listening range may also be done by the network computer 135 using global positioning satellite (GPS) positions of the digital electronic performance device.

FIG. 6 shows a more detailed flow diagram of steps that may be taken to account for each performance in a preferred embodiment of the present invention.

In Step 602: Launch application, the application module may be activated.

In Step 604: Register, the user may, via the application module, validate themselves on the network computer 135 and obtain access to their user profile and preferences.

In Step 606: Updated playlist, an updated playlist may have generated on the network computer 135. This may then be transferred to the application module.

In Step 608: Stream song, a song selected from the updated format playlist, may then be accessed from a suitable source such as, but not limited to, a 3^{rd} party streaming catalogue, a record label streaming catalogue, a user's home PC or some combination thereof.

In Step 612: Mark for payment, if the streaming is continued for a certain minimum time that may, for instance, be 30 seconds, information regarding the streamed performance may then be transferred to an accounting module on the network computer 135. The accounting may be done in real time, or it may be batch processed.

In Step 614: Determine permissions the accounting module on the network computer 135 may access the user's profile and preferences files to determine if the user has any performance privilege status such as, but not limited to, permissions to perform the song that may, for instance, have been obtained by purchasing a right to perform the song by buying a CD or by subscribing to a particular service.

In Step 616: Determine rights holders the network computer 135 may access appropriate databases to determine who the current rights holders of the material being performed are. The rights holders may be persons such as, but not limited to, the performing artist 122, the record label 124, or a third party owner or some combination thereof.

In Step 618: Determine payments, the network computer 135 may be used to determine a performance value 150. Determining the performance value 150 may include taking into account any performance privilege status. It may also include determining a performance audience that may, for instance, include estimating a number of people within listening range of the digital electronic performance device 125, or connected to it.

The network computer 135 may also serve to bill at least one member of the performance audience for the performance payment fee 150.

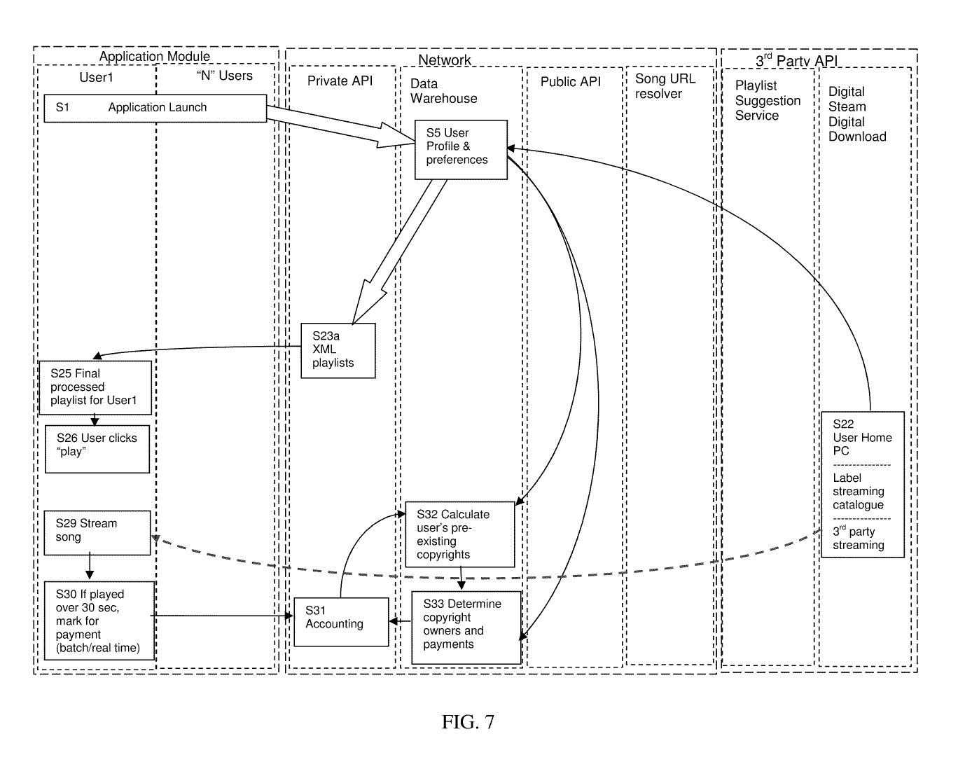

FIG. 7 shows a schematic interaction diagram showing interactions that may occur in accounting for each performance in a preferred embodiment of the invention.

In step S1, the application may be launched, and via steps shown in detail in FIG. 10, and proceed to step S5 in which the user's profile and preferences may be accessed.

The method may then proceed to step S23A via steps shown in detail in FIG. 10. At step S23A the user's playlist that may have been retrieved or created on the network computer 135, may be placed on an API for retrieval. The user's playlist may not contain any performance data but instead consist of metadata about the song such as, but not limited to, the title, the artist, and a URL of at least one digital copy of the content, also known as the mechanical 160 or some combination thereof.

In step S25, the final processed playlist is made available to the application module. The user may then, in step S26, select a song to play. In step 29, the application module may use the metadata to stream a performance of the requested song from an appropriate 3^{rd} third party location to the digital electronic performance device 125.

In step S30, the application module may determine if the song was listened to for more than a predetermined time that may, for instance, be a time in the range of 5 to 60 seconds and is more preferably 30 seconds. If the song was listened to for a predetermined time, the song may then be marked for payment. The information may be transferred an accounting API S31 to the network computer 135, and may include instructions as to whether the payment processing is required in real time or in a batch mode.

In step S32, the accounting module may calculate any pre-existing copyrights that the user may have.

In step S33, the accounting module may determine who the copyright owners are and what, if any, payments they are due.

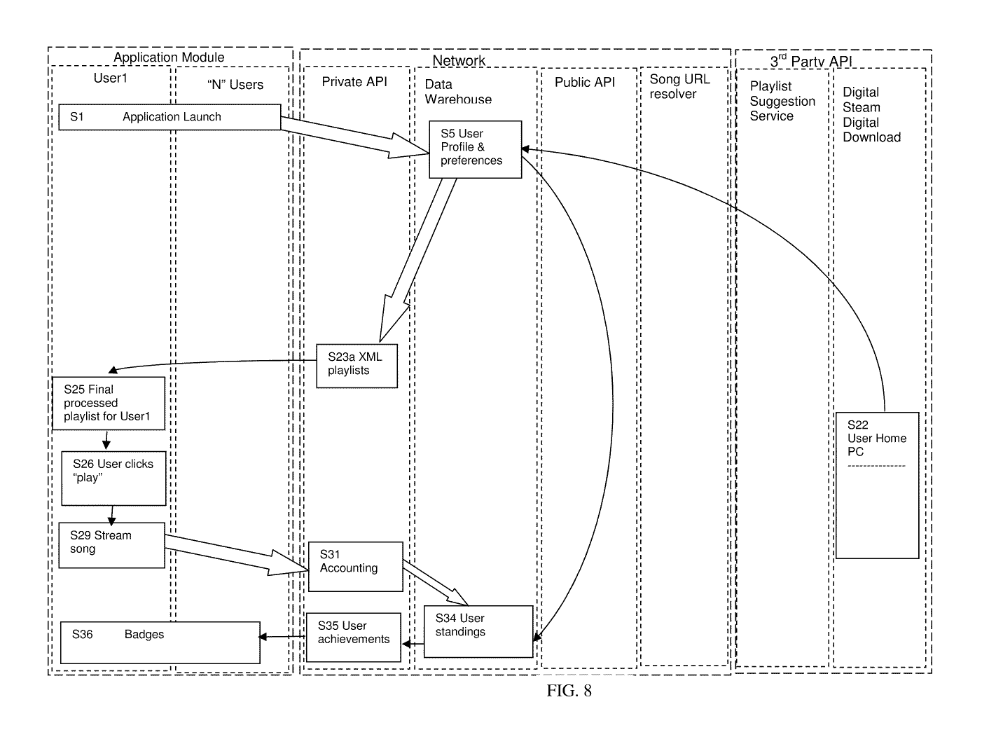

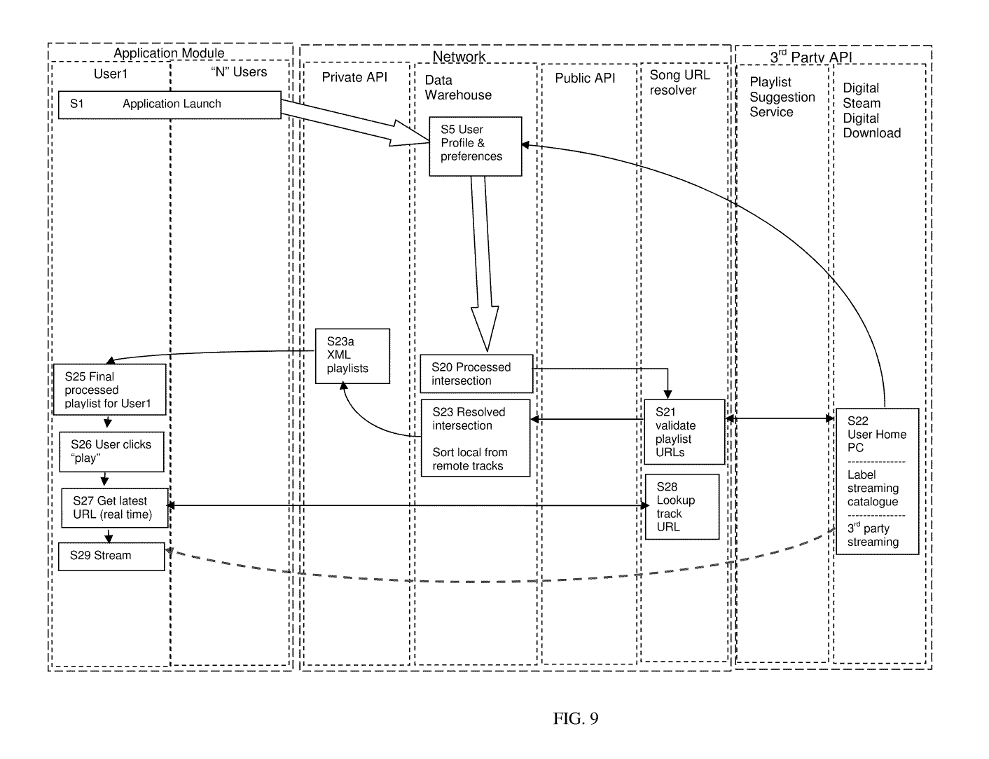

FIG. 8 shows a schematic interaction diagram showing interactions that may occur in payment processing in a preferred embodiment of the invention.

The application may be launched in step S1, and then proceed as discussed above, to step S29 in which the song is streamed.

The process may then proceed to step 31, via steps shown in detail in FIG. 10, in which data concerning the performance may be transferred to an accounting module on the network computer 135.

The process may then proceed to step S34 via steps shown in detail in FIG. 10, in which the user's standings may be inspected. These standings may include elements such as, but not limited to, a number of songs played, a number of songs shared, a number of venues visited, a number of friends followed or some combination thereof.

In step S35, the user standings may be converted in user achievements. These achievements may include game mechanics elements such as, but not limited to, position on a leader board, mayor of a venue, achievement of a badge worth task, or some combination thereof. The achievements may also be used in payment, or partial payment, of actual rights fees. In a preferred embodiment, the achievements may be converted to actual rights via sponsorship, advertising or direct payment by a company promoting a product, or some combination thereof.

FIG. 9 shows a schematic interaction diagram showing interactions that may occur in dynamic sourcing of a mechanical in a preferred embodiment of the invention.

The system may proceed to state S26 via steps discussed in detail above or shown in detail in FIG. 10. In state S26, the user may select a song to be played. The application module may then proceed to step S27 in which it may accesses a song URL resolver on the network computer 135 that may have a real time update on possible sources for the digital copy of the content, also known as the mechanical 160.

In state S29, the application module may then stream the song from the most accessible location having an appropriate digital copy of the content, also known as the mechanical 160. As the performance may be controlled by the application module and properly accounted for by the network computer 135, it may be irrelevant where the song is being sourced.

A significant advantage of the dynamic sourcing of the mechanical file of this invention is that the rights holders may be appropriately compensated for the performance regardless of whether the digital copy of the content, also known as the mechanical 160 has been pirated, stolen or is a legitimate copy. Because the performance is streamed with appropriate encryption and decryption software, a copy of the performance cannot be made, so there is minimal danger of file sharing.

FIG. 10 shows a schematic interaction diagram showing interactions that may occur in implementing a preferred embodiment of the invention.

The states shown in FIG. 10 may be followed in numerical order to trace the details of an embodiment of the present invention.

The relevant states are discussed in detail above.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method of accounting for consumption of digital material, said method comprising the steps of:
facilitating, by a digital electronic performance device, a performance of said digital material; and
reporting, by said digital electronic performance device to a network computer, said performance of said digital material.

2. The method of claim 1 further comprising assessing a performance value.

3. The method of claim 2 wherein assessing a performance value further includes determining a performance rights holder of said digital material.

4. The method of claim 3 wherein assessing a performance value further includes determining a performance audience.

5. The method of claim 4 further comprising billing at least one member of said performance audience said performance value.

6. The method of claim 1 further comprising receiving a request, by said network computer, for a performance of said digital material; and providing, by said network computer to said digital electronic performance device, a location of a digital material mechanical.

7. The method of claim 6 wherein facilitating said performance further comprises accessing a third party streaming catalogue.

8. The method of claim 1 wherein facilitating said performance further comprises providing an application module, operative on said digital electronic performance device, to enable a streamed performance of said digital material.

9. The method of claim 8 wherein providing a streamed performance of said digital material occurs without copyable access to said digital material mechanical.

10. The method of claim 8 further comprising deleting, from said digital electronic performance device, data bits retrieved from said digital material mechanical.

11. The method of claim 8 wherein providing a streamed performance further comprises limiting user control of said performance to the group consisting of starting, stopping, controlling a volume of, skipping, fast forwarding, registering love for, registering hate for and repeating.

12. The method of claim 1 wherein determining a performance audience further comprises estimating a number of people within listening range of said digital electronic performance device.

13. The method of claim 12 wherein estimating a number of people within listening range further comprises electronically monitoring at least one mobile device distinct from said digital electronic performance device.

14. The method of claim 13 further comprising determining a performance privilege status of said performance audience regarding said digital material.

15. The method of claim 14 wherein said performance value accounts for said performance privilege status of said performance audience.

16. The method of claim 15 further comprising reporting said performance value to an owner of said digital material.

17. The method of claim 16 wherein said performance value comprises a non-monetary element.
